(19) United States
(12) Patent Application Publication
(10) Pub. No.: US 2006/0273596 A1
(43) Pub. Date: Dec. 7, 2006

(54) Durbin turbine

(76) Inventor: James Clifford Durbin, Amarillo, TX (US)

Correspondence Address: James C. Durbin, 3611 Royal Road, Amarillo, TX, 79109, US

(21) Appl. No.: 11/323,641

(22) Filed: Mar. 9, 2006

(51) Int. Cl. F03B 13/00

(52) U.S. Cl. 290/54

(57) ABSTRACT

The Durbin Turbine is wind operated which is created by the movement of the vehicle. This movement turns the blower/turbine, which then turns the alternator to generate DC/amperage/voltage/AC volts to charge one battery bank while using the other battery bank to operate the vehicle. The turbine/blower will be installed in a tunnel on the roof of the vehicle to achieve maximum wind movement. The wind turbine may also be made as twins with two alternators/generators or four alternators/generators in separate tunnels on the roof of the vehicle. Regulators, rectifiers, transformers, or gears may be used to get the required results on vehicles. Screens and louvers may be used to protect the turbines and/or adjust air flow. This unit would run long distances at highway speed without fueling or charging with a plug-in type charge. This concept would be used on electrical and/or hybrid vehicles. It also could be used for trains and/or electrical aircraft. RPMs in the train generator could be controlled with gears and governors at high track speeds using a vertical turbine. What is new is the concept of mounting a wind charging system attached to a vehicle that charges batteries on electric or hybrid vehicles while the vehicle is in motion, including wind generators on diesel electric trains. The Durbin Turbine may be sold as an after-market item, or manufactured as standard equipment on new vehicles.

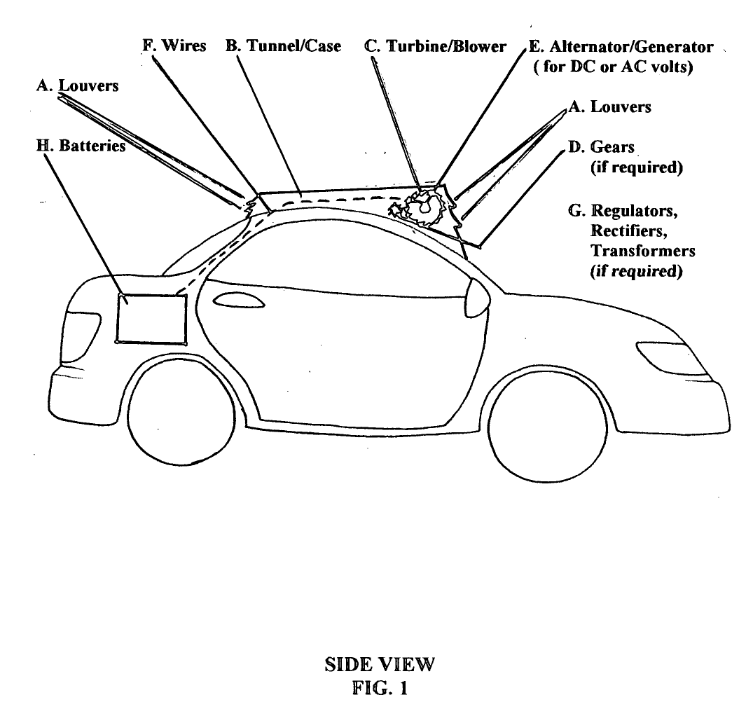

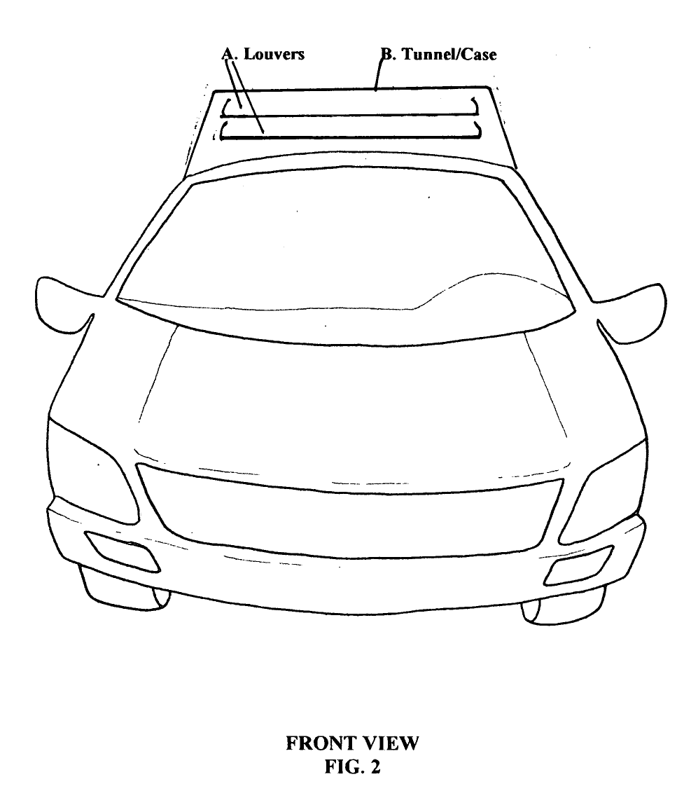

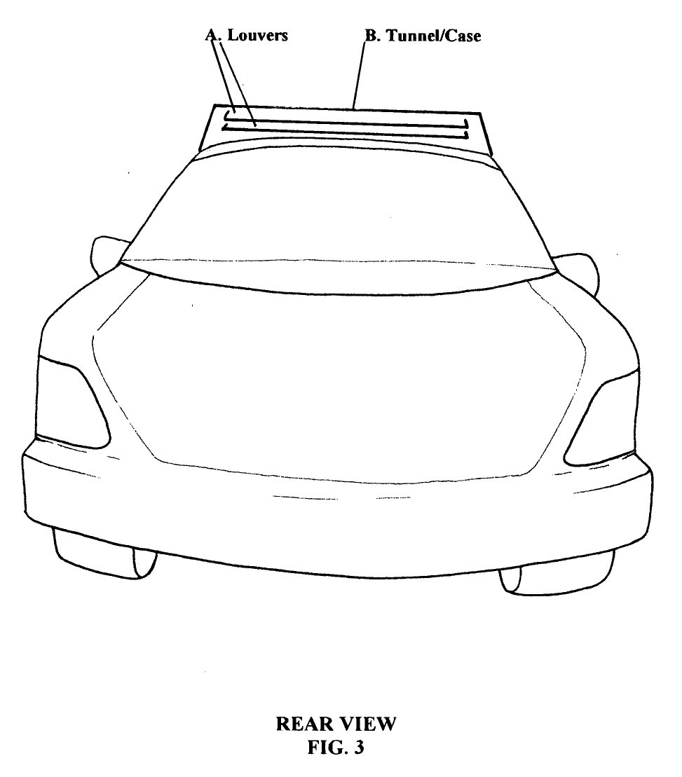

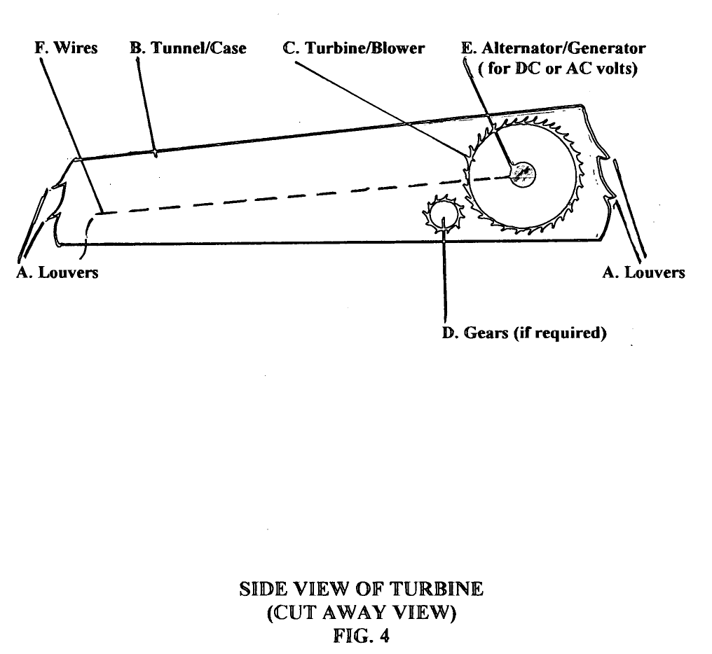

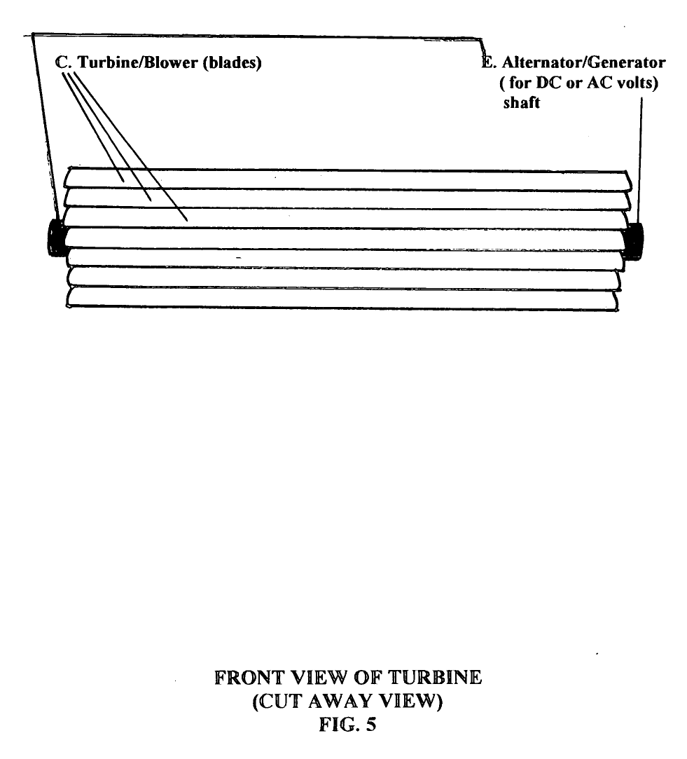

### HOW THE DURBIN TURBINE OPERATES

Wind travels through open louvers [A. front and back] into the tunnel [B.], turning the turbine/blower [C.] which turns the gears [D. (left and right, not visible)]. This turns the alternators [E. left and right] and creates AC/DC voltage traveling through the wires [F.] to regulators, transformers, rectifiers, or converters [G.], as required, for proper voltage to battery bank(s) [H.] to charge the batteries while vehicle is in motion.

1. My invention is the concept of mounting a wind charging system attached to a vehicle that charges batteries on electric or hybrid vehicles while the vehicle is in motion.
